(19) United States
(12) Patent Application Publication
(10) Pub. No.: US 2019/0281859 A1
(43) Pub. Date: Sep. 19, 2019

(54) HOSE FITTING ASSEMBLY FOR FROZEN FOOD DISPENSING MACHINE AND METHOD OF ASSEMBLY

(71) Applicant: Taylor Commercial Foodservice Inc., Rockton, IL (US)

(72) Inventors: Kevin Henry Bischel, Rockton, IL (US); Robert E. Frisque, Rockton, IL (US); James J. Minard, Rockton, IL (US)

(73) Assignee: Taylor Commercial Foodservice Inc., Rockton, IL (US)

(21) Appl. No.: 16/340,306

(22) PCT Filed: Oct. 9, 2017
(86) PCT No.: PCT/US2017/055757

§ 371 Date: Apr. 8, 2019

Related U.S. Application Data
(60) Provisional application No. 62/406,633, filed on Oct. 11, 2016.

(51) Int. Cl. A23G 9/28; F16L 37/38; F16L 37/084

(52) U.S. Cl. CPC A23G 9/28; F16K 15/147; F16L 37/0848; F16L 37/38

(57) ABSTRACT

A hose fitting assembly for connecting to a food mix bag of a frozen food dispensing machine is provided. The hose fitting assembly includes a fitting body defining a hollow fitting body interior. Also included is a probe cap repeatedly matable with the fitting body and having an inner wall defining a hollow probe cap interior.

### CROSS-REFERENCE TO RELATED APPLICATIONS

This application is a U.S. National Stage Application under 35 USC § 371 of PCT/US2017/055757, filed on Oct. 9, 2017, which claimed priority from U.S. Provisional Application No. 62/406,633, filed on Oct. 11, 2016, the entirety of which are each fully incorporated by reference herein.

### BACKGROUND

Exemplary embodiments pertain to the art of food dispensing machines and, more particularly, to a hose fitting assembly for connecting to a food mix bag of a frozen food dispensing machine, as well as a method of assembling the hose fitting assembly.

Liquid mixes and other additives are utilized in frozen food product dispensing machines to flavor drinks, frozen shakes, milkshakes, frozen desserts and other products. The mixes are mixed with ice and/or other ingredients or syrups and dispensed from the machine. The mix for some frozen dessert machines is supplied in plastic bags that have a fitment which must be pierced so the food product can be pumped out. Piercing assemblies often result in leakage of the mix and/or damaging a bag seal that is otherwise reusable. Additionally, piercing assemblies typically require complete replacement of the entire assembly if certain components of the assembly are damaged or worn.

### BRIEF DESCRIPTION

Disclosed is a hose fitting assembly for connecting to a food mix bag of a frozen food dispensing machine. The hose fitting assembly includes a fitting body defining a hollow fitting body interior. Also included is a probe cap repeatedly matable with the fitting body and having an inner wall defining a hollow probe cap interior.

In addition to one or more of the features described above, or as an alternative, further embodiments may include a seal element disposed in a removable manner proximate an end region of the fitting body and the tip structure of the probe cap.

In addition to one or more of the features described above, or as an alternative, further embodiments may include that the seal element is a duckbill valve.

In addition to one or more of the features described above, or as an alternative, further embodiments may include that the seal element is a poppet valve.

In addition to one or more of the features described above, or as an alternative, further embodiments may include that the seal element is an umbrella valve.

In addition to one or more of the features described above, or as an alternative, further embodiments may include that the seal element is a self-sealing single wall valve.

In addition to one or more of the features described above, or as an alternative, further embodiments may include a seal integrally formed with an inner wall of the fitting body.

In addition to one or more of the features described above, or as an alternative, further embodiments may include an O-ring seal disposed between a second end of the probe cap and a flange of the fitting body.

In addition to one or more of the features described above, or as an alternative, further embodiments may include that the O-ring seal is integrally formed with the fitting body.

In addition to one or more of the features described above, or as an alternative, further embodiments may include that the O-ring seal is a replaceable component disposed in a removable manner on the fitting body.

In addition to one or more of the features described above, or as an alternative, further embodiments may include the O-ring seal is integrally formed with the probe cap.

In addition to one or more of the features described above, or as an alternative, further embodiments may include that the probe cap is mated with the fitting body along an outer wall of the fitting body.

In addition to one or more of the features described above, or as an alternative, further embodiments may include that the probe cap includes an annular recess along the inner wall, the annular recess engageable with an annular detent protruding from the fitting body to axially orient the probe cap to the fitting body.

In addition to one or more of the features described above, or as an alternative, further embodiments may include a holding clip disposed in removable engagement with the fitting body, the holding clip coupleable to a fitment of the food mix bag.

In addition to one or more of the features described above, or as an alternative, further embodiments may include a holding clip disposed in removable engagement with the fitting body, the holding clip coupleable to a bin configured to support the food mix bag.

In addition to one or more of the features described above, or as an alternative, further embodiments may include a tip structure of the probe cap and integrally formed therewith, the tip structure disposed proximate a first end of the probe cap and having a central hub and a plurality of spokes extending between the central hub and the inner wall to define a plurality of tip region apertures, the central hub extending axially outwardly of an end region of the fitting body, each of the plurality of spokes tapered.

In addition to one or more of the features described above, or as an alternative, further embodiments may include a magnet, the magnet detectable by a sensor operatively coupled to a fitment of the food mix bag.

Also disclosed is a method of assembling a hose fitting assembly with replaceable components, the hose fitting assembly connectable to a food mix bag of a frozen food dispensing machine. The method includes disposing a seal element between an end region of a fitting body and a probe cap. The method also includes mating the probe cap with the fitting body at the end region to fix the seal element therebetween, wherein the probe cap is repeatedly decoupleable from the fitting body for replacement of the probe cap or the seal element.

In addition to one or more of the features described above, or as an alternative, further embodiments may include disposing an O-ring between an end of the probe cap and a flange of the fitting body, wherein the O-ring is repeatedly decoupleable from the fitting body for replacement of the O-ring. Also included is coupling a holding clip to the fitting body in a repeatedly decoupleable manner for replacement of the holding clip.

### BRIEF DESCRIPTION OF THE DRAWINGS

The following descriptions should not be considered limiting in any way. With reference to the accompanying drawings, like elements are numbered alike:

FIG. 1 is a perspective view of a bin of a frozen food dispensing machine configured to hold a bag of food product;

FIG. 2 is a perspective, partial sectional view, of a hose fitting assembly coupled to a fitment of the bag of food product;

FIG. 3 is a disassembled view of a first end of the hose fitting assembly;

FIG. 4 is a disassembled view of a second end of the hose fitting assembly;

FIG. 5 is a perspective view of the first end of the hose fitting assembly in an assembled condition;

FIG. 6 is a perspective view of the second end of the hose fitting assembly in an assembled condition;

FIG. 7 is a sectional view of a probe cap coupled to a fitting body of the hose fitting assembly illustrating a seal element according to an aspect of the disclosure;

FIG. 8 is a perspective view of a tip structure of the probe cap;

FIG. 9 is a sectional view of the probe cap coupled to a fitting body of the hose fitting assembly illustrating the seal element according to another aspect of the disclosure;

FIG. 10 is a perspective view of the seal element of FIG. 9;

FIG. 11 is a sectional view of the probe cap coupled to a fitting body of the hose fitting assembly illustrating the seal element according to another aspect of the disclosure;

FIG. 12 is a perspective view of the seal element of FIG. 11;

FIG. 13 is a perspective view of the hose fitting assembly according to another aspect of the disclosure;

FIG. 14 is a cross-sectional view of the hose fitting assembly of FIG. 13;

FIG. 15 is a perspective view of the hose fitting assembly of FIG. 13 disengaged from a fitment; and

FIG. 16 is a perspective view of the hose fitting assembly of FIG. 13 engaged with the fitment.

### DETAILED DESCRIPTION

A detailed description of one or more embodiments of the disclosed apparatus and method are presented herein by way of exemplification and not limitation with reference to the Figures.

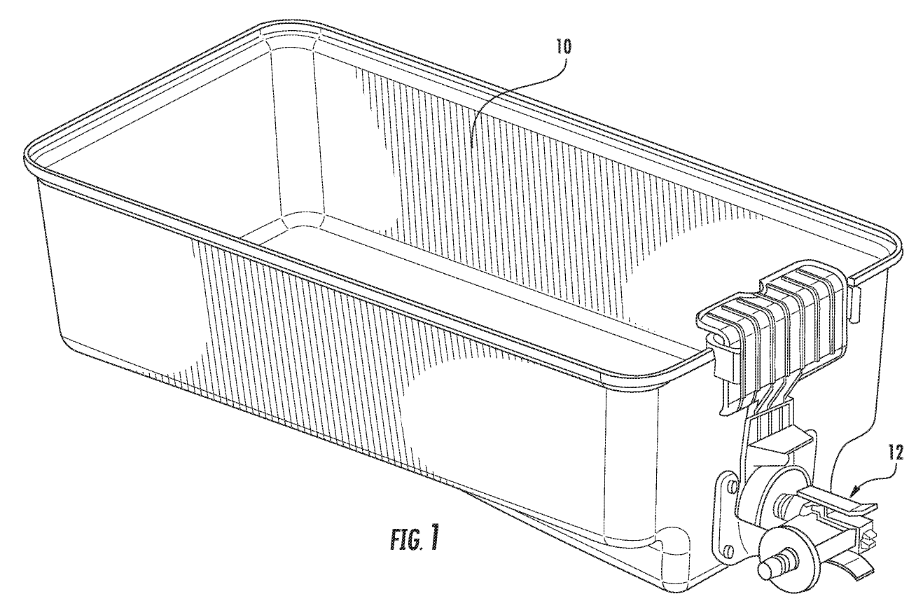

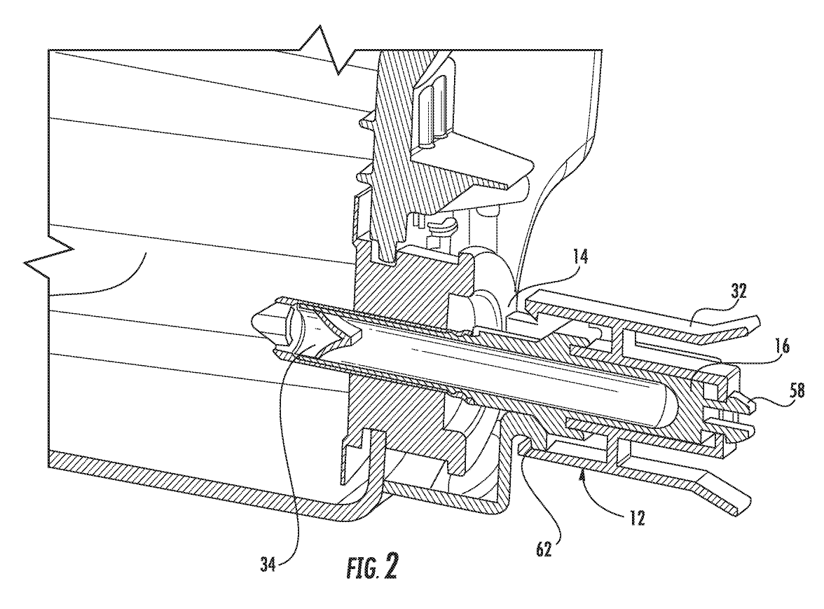

Referring to FIGS. 1 and 2, illustrated is bin 10 that is part of a frozen food product dispensing machine (not shown). The bin 10 supports a food product bag (not shown), as described in detail below. While a single bin and associated components of a single bin are described herein, it is to be appreciated that the product dispensing machine may include a plurality of bins to each hold a respective food product bag.

The product dispensing machine is adapted to sit on a floor of a food service establishment and may have casters to facilitate its movement on the floor in some embodiments. In other embodiments, the product dispensing machine is elevated on a platform, stand, counter or the like. The product dispensing machine includes a housing which houses one or more refrigeration systems (not shown). The one or more refrigeration systems can be energized by a power source for cooling or refrigerating an interior cavity defined by the housing and any contents housed within. In some non-limiting examples, the one or more refrigeration systems may be energized by an AC supply, DC supply, battery, fuel cell, AC or DC generator, solar power, or the like.

The product dispensing machine includes at least one dispensing station at an upper front region of the housing for use in dispensing, in some examples, iced beverages, milkshakes, or soft-serve products to customers. The preceding list of food products is merely illustrative and not intended to be limiting. The refrigeration system is utilized for keeping the contents of the bin 10 refrigerated, but in another embodiment, the refrigeration system may be de-energized if the contents of the bin 10 are to be non-refrigerated.

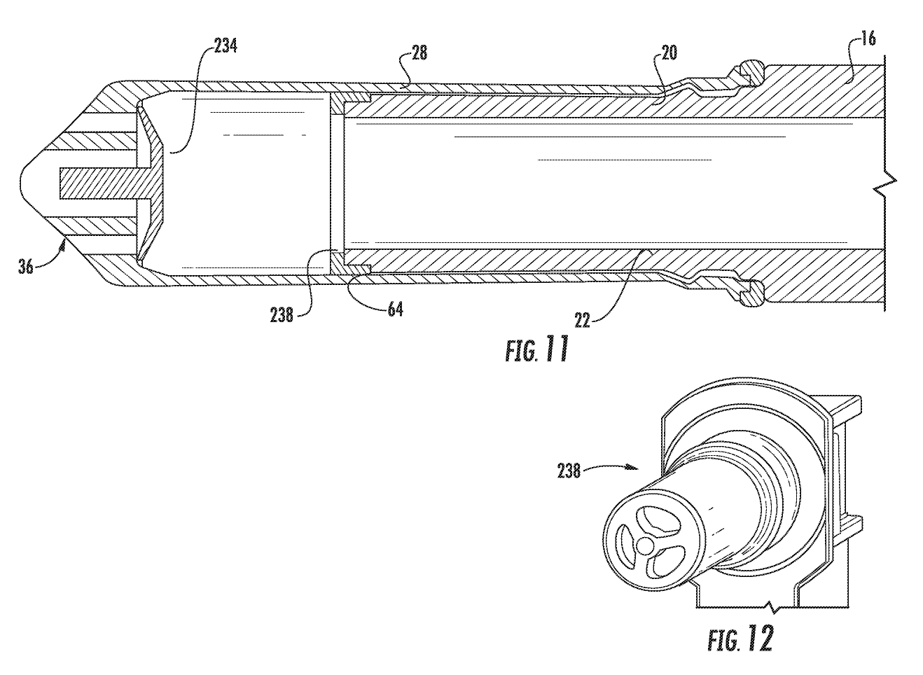

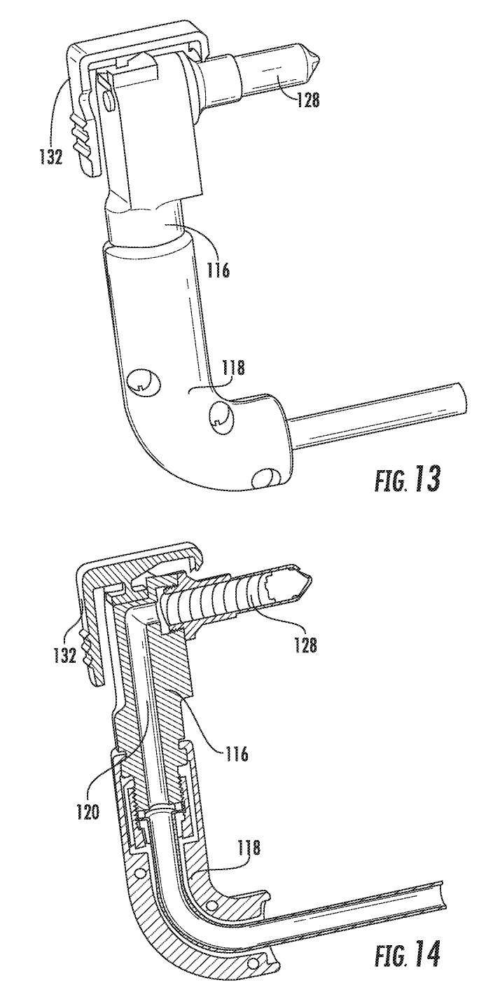

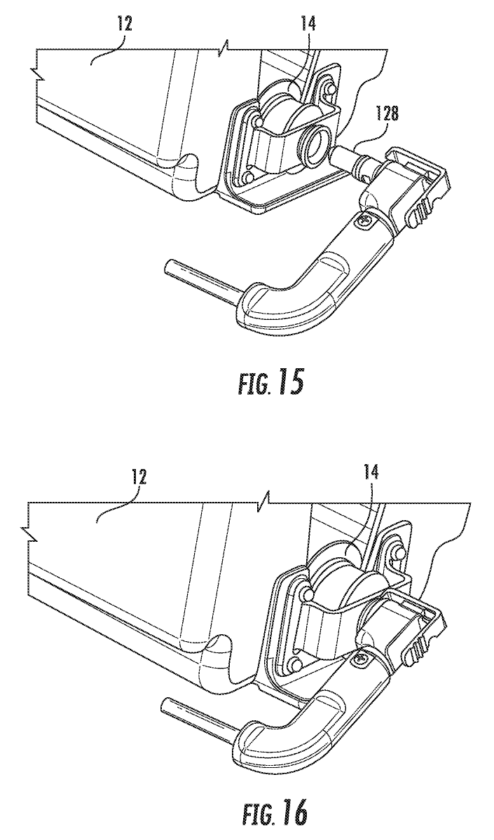

As noted above, the bin 10 is configured to support and contain a food product bag, such as diary food stuff bags, syrup bags, or any other product used to produce the final dispensed product. The food product bag is fluidly coupled to a mixing or dispensing region of the product dispensing machine via a hose. Fluid coupling is established with a hose fitting assembly 12 that couples to a hose and to a fitment 14 (FIG. 2) of the food product bag disposed within the bin 10. In some embodiments, the hose fitting assembly 12 couples to a fitment 14 that is part of, or coupled to, the bin 10, as shown in FIGS. 13-16, instead of the food product bag. The hose fitting assembly 12 disclosed herein pierces the fitment 14 of the food product bag in a manner that avoids leakage or damaging a reusable bag seal. The hose fitting assembly locks in place, is food safe and cleanable, and includes numerous replaceable components if damage or wear occurs, thereby avoiding replacement of the entire hose fitting assembly 12.

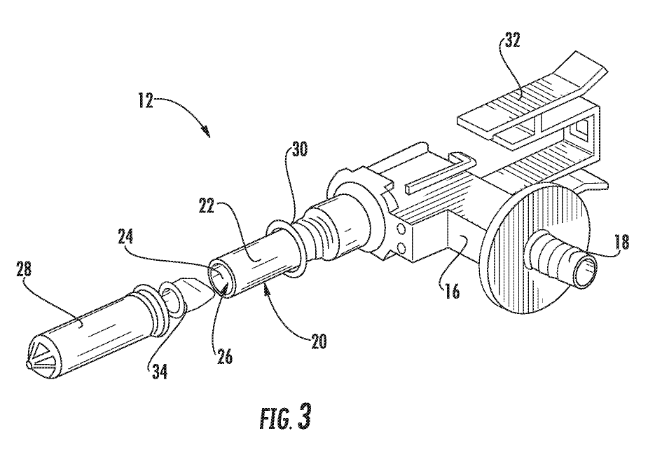

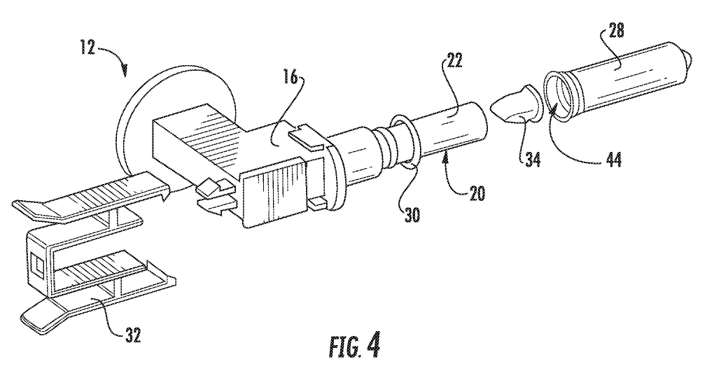

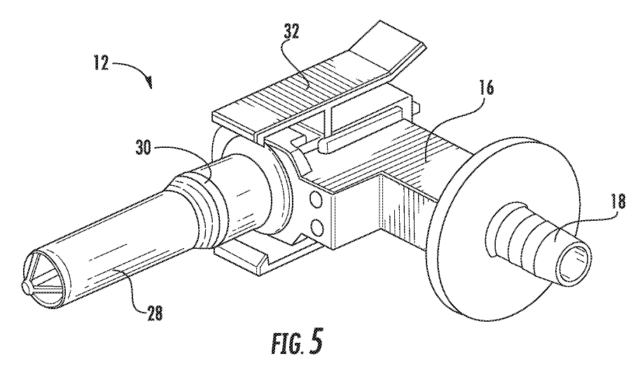

Referring now to FIGS. 3-6, with continued reference to FIG. 2, the hose fitting assembly 12 is illustrated in greater detail. The assembly 12 is shown in a disassembled condition (FIGS. 3 and 4) and an assembled condition (FIGS. 5 and 6). The assembly 12 includes a fitting body 16 having a hose mating port 18 and a tubular portion 20. Although substantially L-shaped in the illustrated embodiment, it is to be understood that alternative general geometries may be employed. The tubular portion 20 includes an outer wall 22 and an inner wall 24. The inner wall 24 defines a hollow fitting body interior 26. The hollow fitting body interior 26 allows fluid flow of the food product to a hose (not shown) that is connected to the hose mating port 18. The assembly 12 also includes a probe cap 28, an O-ring seal 30, a holding clip 32, and a seal element 34, as described in detail herein.

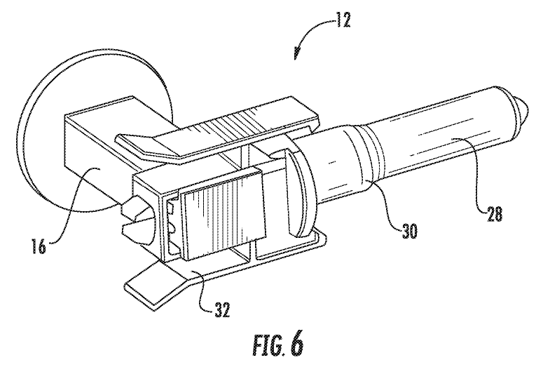

Referring now to FIG. 8, a tip structure 36 of the probe cap 28 is illustrated in greater detail. The probe cap 28 extends from a first end 38 to a second end 40. The tip structure 36 is located at the first end 38 of the probe cap 28 and integrally formed therewith. The tip structure 36 is configured to pierce the fitment 14 and allow the food product to flow to the hollow fitting body interior of the fitting body 16. The probe cap 28 includes an inner wall 42 (FIG. 7) that defines a hollow probe cap interior 44 (FIG. 4). The tip structure 36 includes a central hub 46 and a plurality of spokes 48 extending between the central hub 46 and the inner wall 42 of the probe cap 28. In addition to the radial direction of extension of the spokes 48, the spokes are tapered in an angled manner as they extend radially. This is due to the axial position of the central hub 46. The central hub 46 extends axially to an extent further than the first end 38 of the tubular portion of the probe cap 28. The angled orientation of the spokes 48 and the extended central hub 46 allows the tip structure 36 to more effectively pierce the fitment 14 of the bag. In particular, piercing is performed with reduced force, less leakage and less chance of seal damage relative to a blunt tip design. The spokes 48 define multiple apertures 50 for the food product to flow through.

Referring to FIG. 7, the probe cap 28 is dimensioned to engage the tubular portion 20 of the fitting body 16 in a mating manner. More specifically, the probe cap 28 may be engaged and disengaged from the tubular portion 20 in a repeatable manner, thereby making the probe cap 28 a replaceable component. In the illustrated embodiment, the probe cap 28 is disposed radially outward of the tubular portion 20. In other words, the probe cap 28 slides over the tubular portion 20. However, it is contemplated that the probe cap 28 is disposed within (i.e., radially inward) the tubular portion 20 in some embodiments. In the illustrated embodiment, the probe cap 28 is slid over the outer wall 22 of the tubular portion 20 until the second end 40 of the probe cap 28 engages the O-ring seal 30 disposed adjacent a flange 52 of the fitting body 16. The O-ring seal 30 may be integrally formed with the fitting body 16 as an overmolded feature. Alternatively, the O-ring seal 30 may be a separate component that is disposed in a removable manner with the fitting body 16, thereby making the O-ring seal 30 a replaceable component. Regardless of whether the O-ring seal 30 is integrally formed with, or removably coupled to, the fitting body 16, the seal 30 seals the interface between the probe cap 28 and the fitting body 16 to prevent leakage of the food product flowing therein.

As shown, positioning and engagement of the probe cap 28 may be facilitated by the inclusion of a detent-recess arrangement. In the illustrated embodiment, the inner wall 42 of the probe cap 28 defines an annular recess 54 that is sized to correspond to a detent 56 protruding from the outer wall 22 of the tubular portion 20 of the fitting body 16, thereby snapping the probe cap 28 into engagement with the fitting body 16 to provide assembly personnel confirmation that the probe cap 28 is fully engaged.

Referring to FIG. 2, the holding clip 32 is shown in an engaged condition relative to the fitting body 16 and the fitment 14 to further couple the hose fitting assembly 12 to the fitment 14. The holding clip 32 is retained to the fitting body 16 with one or more clips. In the illustrated embodiment, the fitting body 16 includes a pair of clips 58 that retain structural features of the holding clip 32 to couple the holding clip 32 to the fitting body 16 in a repeatedly removable manner. It is contemplated that the holding clip 32 has one or more clips that retain flanges of the fitting body 16 in some embodiments. The holding clip 32 also couples to the fitment 14 with at least one clip 62 that snaps over flanges of the fitment 14 in a repeatedly removable manner. The clips 58 of the fitting body 16 and the clip(s) 62 of the holding clip 32 are plastic living hinges in some embodiments. The repeatedly removable and coupleable attachment of the holding clip to both the fitting body 16 and the fitment 14 make the holding clip 32 a replaceable component.

To ensure coupling of the hose fitting assembly 12 to the fitment 14, a magnet and sensor arrangement may be provided. In an embodiment, the magnet is disposed within, or on, the hose fitting assembly 12 and the sensor is part of the fitment 14 for detection of coupling. In another embodiment, the magnet is disposed within, or on, the fitment 14 and the sensor is part of the hose fitting assembly 12 for detection of coupling.

In the illustrated embodiment, the clip 32 is attached to the fitting body 16 using cantilevered clips 58. In some embodiments, the clip 32 may be attached to the fitting body 16 by other methods such as the fitting body 16 having a threaded post that would extend through the clip 32 with a removable threaded knob holding the clip 32 in place. The clip 32 could then be removed by first removing such a knob.

Referring now to FIGS. 2-7, the seal element 34 is illustrated according to an aspect of the disclosure. The seal element 34 is disposed within the flow path of the hose fitting assembly 12 to prevent food product leakage when the assembly 12 is detached from the fitment 14. The seal element 34 is a duckbill valve in the illustrated embodiment. The seal element 34 is disposed within the hollow fitting body interior 26 proximate an end 64 of the tubular portion 20. The seal element 34 includes an annular flange 68 that is disposed between a flange 70 of the probe cap 28 and the end 64 of the tubular portion 20 to seal the interface. The seal element 34 is removable from the interior portion based on the removability of the probe cap 28, thereby making the seal element 34 a replaceable component.

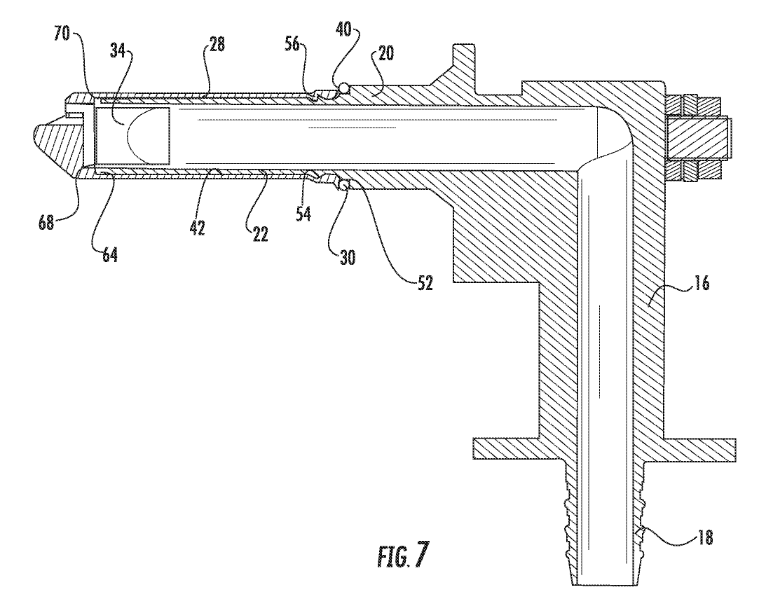

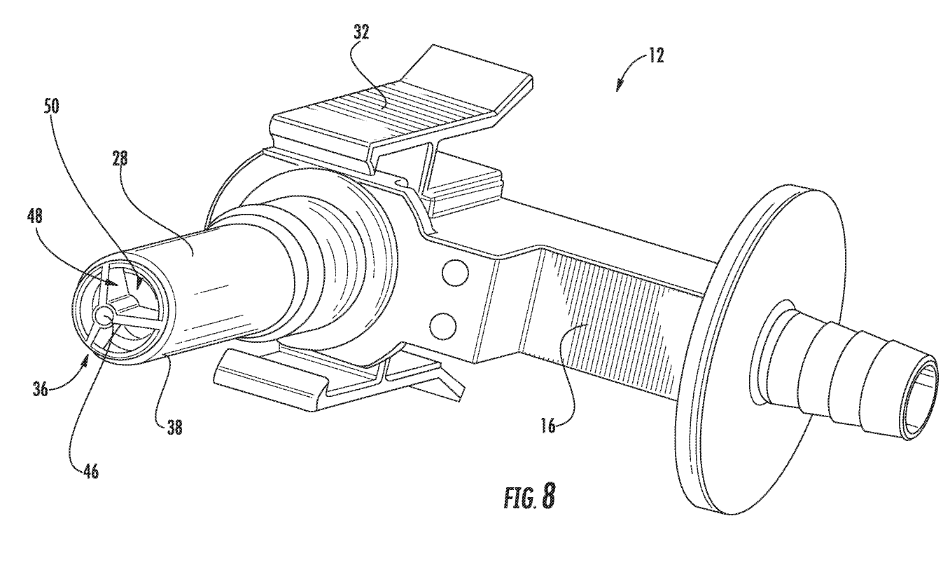

Referring now to FIGS. 9 and 10, another embodiment of the above-described seal element is illustrated and referenced with numeral 134. The seal element 134 is a poppet valve that is disposed in the flow path of the hose fitting assembly 12. The seal element 134 includes a seal 136 that is disposed adjacent the tip structure 36 of the probe cap 28 within the hollow probe cap interior 44. An overmolded annular seal 138 extending from the inner wall 22 of the tubular portion 20 proximate the end 64 thereof seals between the probe cap 28 and the tubular portion 20. The seal 136 is biased toward the first end 38 of the probe cap 28 with a spring 140 that is disposed within the hollow probe cap interior 44. The spring 140 applies a force to seal when a zero differential pressure is present. The poppet valve abuts the seal 138 for axial structural support.

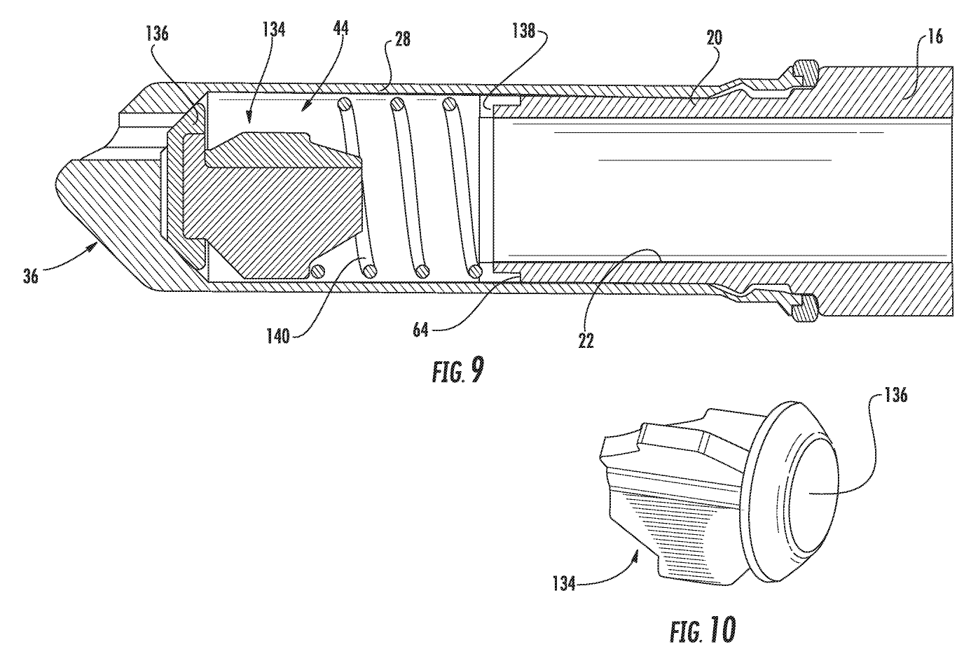

Referring now to FIGS. 11 and 12, another embodiment of the above-described seal element is illustrated and referenced with numeral 234. The seal element 234 is an umbrella valve that is disposed in the flow path of the hose fitting assembly 12. An overmolded annular seal 238 extending from the inner wall 22 of the tubular portion 20 proximate the end 64 thereof seals between the probe cap 28 and the tubular portion 20. The umbrella valve abuts the seal 238 for axial structural support.

The illustrated and above-described seal elements are merely illustrative of the types of seals that may be employed within the flow path of the hose fitting assembly 12 to prevent leakage proximate the tip structure 36 of the probe cap 28. For example, a self-sealing single wall valve may be employed, in addition to other contemplated seal elements.

FIGS. 13-16 illustrate another embodiment of the hose fitting assembly. As shown, the hose fitting assembly includes a fitting body 116 having a tubular portion 120. The tubular portion 120 allows fluid flow of the food product to a hose (not shown) that is connected to the hose mating port 118. The assembly also includes a probe cap 128 and a holding clip 132. The probe cap 128 is operatively coupled to the fitting body 116. In the illustrated example, the probe cap 128 is threaded to the fitting body 116. Similarly, a hose mating port is operatively coupled to the fitting body 116, such as in a threaded manner. The holding clip 132 is a single, integrally formed component in the illustrated example.

In addition to the above-described functional advantages achieved with the hose fitting assembly 12 related to reduced leakage and self-locking, for example, the assembly is provided with numerous replaceable components, thereby avoiding replacement of the entire assembly when a single component is damaged or worn out. This reduces the maintenance costs and the warranty cost of the frozen dessert machine in which it is used.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A hose fitting assembly for connecting to a food mix bag of a frozen food dispensing machine, the hose fitting assembly comprising:
a fitting body defining a hollow fitting body interior; and
a probe cap repeatedly matable with the fitting body and having an inner wall defining a hollow probe cap interior.

2. The hose fitting assembly of claim 1, further comprising a seal element disposed in a removable manner proximate an end region of the fitting body and the tip structure of the probe cap.

3. The hose fitting assembly of claim 2, wherein the seal element is a duckbill valve.

4. The hose fitting assembly of claim 2, wherein the seal element is a poppet valve.

5. The hose fitting assembly of claim 2, wherein the seal element is an umbrella valve.

6. The hose fitting assembly of claim 2, wherein the seal element is a self-sealing single wall valve.

7. The hose fitting assembly of any of claims 2-6, further comprising a seal integrally formed with an inner wall of the fitting body.

8. The hose fitting assembly of any of claims 1-7, further comprising an O-ring seal disposed between a second end of the probe cap and a flange of the fitting body.

9. The hose fitting assembly of claim 8, wherein the O-ring seal is integrally formed with the fitting body.

10. The hose fitting assembly of claim 8, wherein the O-ring seal is a replaceable component disposed in a removable manner on the fitting body.

11. The hose fitting assembly of claim 8, wherein the O-ring seal is integrally formed with the probe cap.

12. The hose fitting assembly of any of claims 1-11, wherein the probe cap is mated with the fitting body along an outer wall of the fitting body.

13. The hose fitting assembly of claim 12, the probe cap comprising an annular recess along the inner wall, the annular recess engageable with an annular detent protruding from the fitting body to axially orient the probe cap to the fitting body.

14. The hose fitting assembly of any of claims 1-13, further comprising a holding clip disposed in removable engagement with the fitting body, the holding clip coupleable to a fitment of the food mix bag.

15. The hose fitting assembly of any of claims 1-13, further comprising a holding clip disposed in removable engagement with the fitting body, the holding clip coupleable to a bin configured to support the food mix bag.

16. The hose fitting assembly of any of claims 1-15, further comprising a tip structure of the probe cap and integrally formed therewith, the tip structure disposed proximate a first end of the probe cap and having a central hub and a plurality of spokes extending between the central hub and the inner wall to define a plurality of tip region apertures, wherein the central hub extends axially outwardly of an end region of the fitting body, each of the plurality of spokes tapered.

17. The hose fitting assembly of any of claims 1-16, further comprising a magnet, the magnet detectable by a sensor operatively coupled to a fitment of the food mix bag.

18. A method of assembling a hose fitting assembly with replaceable components, the hose fitting assembly connectable to a food mix bag of a frozen food dispensing machine, the method comprising:
disposing a seal element between an end region of a fitting body and a probe cap; and
mating the probe cap with the fitting body at the end region to fix the seal element therebetween, wherein the probe cap is repeatedly decoupleable from the fitting body for replacement of the probe cap or the seal element.

19. The method of claim 18, further comprising:
disposing an O-ring between an end of the probe cap and a flange of the fitting body, wherein the O-ring is repeatedly decoupleable from the fitting body for replacement of the O-ring; and
coupling a holding clip to the fitting body in a repeatedly decoupleable manner for replacement of the holding clip.
